(19) United States
(12) Patent Application Publication
(10) Pub. No.: US 2015/0264486 A1
(43) Pub. Date: Sep. 17, 2015

(54) PLANAR DIAPHRAGM AND SPEAKER EMPLOYING THE SAME

(71) Applicant: MERRY ELECTRONICS (SUZHOU) CO., LTD., SUZHOU CITY (CN)

(72) Inventors: Yuan YUAN, Taichung City (TW); Tse-Yu LIU, Taichung City (TW)

(73) Assignee: MERRY ELECTRONICS (SUZHOU) CO., LTD., SUZHOU CITY (CN)

(21) Appl. No.: 14/206,588

(22) Filed: Mar. 12, 2014

(51) Int. Cl. H04R 7/04; H04R 1/00

(52) U.S. Cl. CPC H04R 7/04; H04R 1/00

(57) ABSTRACT

A planar diaphragm and a speaker employing the same are disclosed. The planar diaphragm includes a diaphragm body on which a voice coil is arranged. The voice coil is a graphene pattern arranged on the diaphragm body by printing. By printing the voice coil of graphene pattern on the diaphragm body of the planar diaphragm, the acoustic characteristics of the planar diaphragm is enhanced and the planar diaphragm is lightweight, excellent in heat dissipation, and convenient and cost-saving in manufacturing and processing.

### BACKGROUND OF THE INVENTION

1. Field of the Invention

The present invention relates generally to speakers, and more particularly, to a planar diaphragm and a speaker employing the same.

2. Description of the Related Art

Conventional diaphragms of speakers are generally configured having a cone shape or a shape with ball-like dome. To achieve satisfied acoustic effect and power effect, the conventional diaphragms are usually made having a relatively bigger size, which can hardly meet the specification requirements of small electronic appliances such as mobile phones. Besides, the materials involved in processes of making the conventional diaphragm are quite complicated. With the development of the planar speaker, the aforesaid problems are solved. However, in general planar speakers of prior art, planar diaphragms are made by forming voice coil pattern on metal foil with photolithography technique. Because of the limitation of the materials of diaphragm and voice coil, the planar speakers of prior art have disadvantages of high production costs, low input power and low electro-acoustic conversion efficiency.

### SUMMARY OF THE INVENTION

The present invention has been accomplished under the circumstances in view. It is an objective of the present invention to provide a planar diaphragm, which has better characteristics and can be conveniently manufactured, and a speaker employing the same.

To attain the above-mentioned objective, the technical solution adopted by the present invention is to provide a planar diaphragm comprising a diaphragm body and a voice coil arranged on the diaphragm body. The voice coil is a graphene pattern arranged on the diaphragm body by printing.

Preferably, the diaphragm body is one of the polymer diaphragm body, metal diaphragm body, alloy diaphragm body, ceramic diaphragm body, graphite diaphragm body, liquid crystal polymer diaphragm body, high elastic fiber diaphragm body and composite diaphragm body.

The present invention also provides a method of making the above-mentioned diaphragm, comprising the following steps:

a) printing graphene on a diaphragm body to form a voice coil pattern; and

b) baking the diaphragm body printed with the voice coil pattern at a temperature of 100° C. to 500° C.

Preferably, the step a) is performed by gravure printing, relief printing, screen printing or electronic printing.

The present invention also provides a speaker employing the above-mentioned planar diaphragm.

By means of the above-mentioned technical solution, the present invention has the following advantages compared to the prior art.

Because the graphene voice coil pattern printed on the diaphragm body is adopted by the present invention, the acoustic characteristics of the planar diaphragm can be enhanced and the planar diaphragm is lightweight, excellent in heat dissipation, and convenient and cost-saving in manufacturing and processing.

### BRIEF DESCRIPTION OF THE DRAWINGS

FIG. 1 is a schematic drawing of the planar diaphragm of the present invention.

### DETAILED DESCRIPTION OF EMBODIMENTS

The present invention will become more fully understood from the detailed description given herein below and the accompanying drawing showing an embodiment of the present invention.

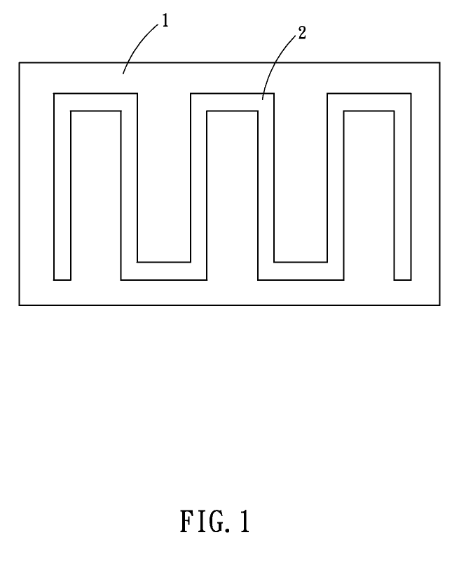

FIG. 1 schematically shows an embodiment of the present invention. As shown in FIG. 1, a planar diaphragm is provided comprising a diaphragm body 1 made of polymer material, and a voice coil 2 arranged on the diaphragm body 1. The voice coil 2 is printed on the diaphragm body 1 and is a graphene pattern.

The method of making the planar diaphragm of this embodiment comprises the following steps.

a) Print a pattern of voice coil 2 on the diaphragm body 1 by electronic printing using graphene.

b) Bake the diaphragm body 1, on which the pattern of the voice coil 2 is printed, at a temperature of 100° C. to 500° C. to dry the graphene pattern.

After the planar diaphragm is electrically powered, the planar diaphragm is completely actuated in magnetic gap. The planar diaphragm of the present invention is thinner and lightweight without phase difference in acting force and has high energy conversion efficiency, low distortion, and wide frequency response. The planar diaphragm of the present invention can be easily driven and well controlled and has good transient properties.

Because the present invention adopts the voice coil pattern of graphene printed on the diaphragm body 1, the acoustic characteristics of the planar diaphragm can be enhanced and the planar diaphragm is lightweight, excellent in heat dissipation, and convenient in manufacturing and processing, which reduces the manufacturing cost.

It should be understood that the detailed description and specific example, while indicating preferred embodiment of the invention, are given by way of illustration only, and thus are not limitative of the present invention. The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A planar diaphragm comprising a diaphragm body on which a voice coil is arranged; wherein the planar diaphragm is characterized in that the voice coil is a graphene pattern arranged on the diaphragm body by printing.

2. The planar diaphragm as claimed in claim 1, wherein the diaphragm body is selected from the group consisting of polymer diaphragm body, metal diaphragm body, alloy diaphragm body, ceramic diaphragm body, graphite diaphragm body, liquid crystal polymer diaphragm body, high elastic fiber diaphragm body and composite diaphragm body.

3. A method of making the planar diaphragm of claim 1, comprising the following steps:
a) printing graphene on a diaphragm body to form a voice coil pattern; and
b) baking the diaphragm body printed with the voice coil pattern at a temperature of 100-500° C.

4. The method as claimed in claim 3, wherein the step a) is carried out by gravure printing, relief printing, screen printing or electronic printing.

5. A speaker employing the planar diaphragm of claim 1.
